(19) United States
(12) Patent Application Publication
(10) Pub. No.: US 2019/0302584 A1
(43) Pub. Date: Oct. 3, 2019

(54) IMAGE PROJECTION APPARATUS

(71) Applicant: Masamichi YAMADA, Kanagawa (JP)

(72) Inventor: Masamichi YAMADA, Kanagawa (JP)

(73) Assignee: Ricoh Company, Ltd., Tokyo (JP)

(21) Appl. No.: 16/353,092

(22) Filed: Mar. 14, 2019

(30) Foreign Application Priority Data
Mar. 28, 2018 (JP) 2018-062937

(51) Int. Cl. G03B 21/14; G03B 21/00; G03B 21/28

(52) U.S. Cl. CPC G03B 21/145; G03B 21/16; G03B 21/28; G03B 21/008

(57) ABSTRACT

An image projection apparatus includes an image displayer on which an image is formed; an illuminator configured to illuminate the image displayer; and an optical projector configured to project the image formed on the image displayer. A plurality of spacers having different thicknesses from each other is disposed between the illuminator and the image displayer or between the illuminator and the optical projector. Each of the plurality of spacers having a different thickness is configured to have a greater thickness as a size is larger, or to have a greater thickness as the size is smaller, the size being a size of a surface perpendicular to a thickness direction of each of the plurality of spacers.

### CROSS-REFERENCE TO RELATED APPLICATION

The present application is based on and claims priority under 35 U.S.C. § 119 to Japanese Patent Application No. 2018-062937, filed on Mar. 28, 2018, the contents of which are incorporated herein by reference in their entirety.

### BACKGROUND OF THE INVENTION

### 1. Field of the Invention

The present invention relates to an image projection apparatus.

### 2. Description of the Related Art

There is known an image projection apparatus, in which an image display unit, including a Digital Micromirror Device (DMD), etc., forms an image by using illumination light from an illumination unit, based on image data transmitted from a personal computer or a digital camera, etc., and a projection optical unit, including a plurality of lenses, projects the image on a screen, etc.

In some cases, the DMD and the lenses forming the image projection apparatus, or holding parts for holding these elements, etc., have manufacturing variations to some extent within the tolerance range. Therefore, at the time of manufacturing the image projection apparatus, the position and the focus of the projection image are adjusted for each image projection apparatus, to eliminate the influence of the manufacturing variations of the parts. In adjusting the position and the focus of the projection image, the distance between the illumination unit and the image display unit, or the distance between the illumination unit and the projection optical unit, etc., is adjusted.

In order to make such an adjustment, there is disclosed an apparatus in which plural plate members, differing in thickness in units of 0.1 mm, are selected and disposed as intermediate members between the illumination unit and the projection optical unit, so that the distance between the illumination unit and the projection optical unit is adjusted in units of 0.1 mm (see, for example, Patent Document 1).

Patent Document 1: Japanese Unexamined Patent Application Publication No. 2013-097326

### SUMMARY OF THE INVENTION

An aspect of the present invention provides an image projection apparatus in which one or more of the disadvantages of the related art are reduced.

According to one aspect of the present invention, there is provided an image projection apparatus including an image displayer on which an image is formed; an illuminator configured to illuminate the image displayer; and an optical projector configured to project the image formed on the image displayer, wherein a plurality of spacers having different thicknesses from each other is disposed between the illuminator and the image displayer or between the illuminator and the optical projector, and each of the plurality of spacers having a different thicknesses is configured to have a greater thickness as a size is larger, or to have a greater thickness as the size is smaller, the size being a size of a surface perpendicular to a thickness direction of each of the plurality of spacers.

### BRIEF DESCRIPTION OF THE DRAWINGS

FIG. 1 is a diagram illustrating an image projection apparatus according to a first embodiment of the present invention;

FIG. 2 is a block diagram illustrating a functional configuration of the image projection apparatus according to the first embodiment of the present invention;

FIG. 3 is a perspective view illustrating an optical engine of the image projection apparatus according to the first embodiment of the present invention;

FIG. 4 is a diagram illustrating an illumination unit according to the first embodiment of the present invention;

FIG. 5 is a diagram illustrating an internal configuration of a projection optical unit according to the first embodiment of the present invention;

FIG. 6 is a perspective view illustrating an image display unit according to the first embodiment of the present invention;

FIG. 7 is a side view illustrating an image display unit according to the first embodiment of the present invention;

FIG. 8 is a perspective view illustrating a fixed unit according to the first embodiment of the present invention;

FIG. 9 is an exploded perspective view illustrating the fixed unit according to the first embodiment of the present invention;

FIG. 10 is a diagram for describing a supporting structure of a movable plate by the fixed unit according to the first embodiment of the present invention;

FIG. 11 is a partial enlarged view for describing a supporting structure of the movable plate by the fixed unit according to the first embodiment of the present invention;

FIG. 12 is a bottom view illustrating the top cover according to the first embodiment of the present invention;

FIG. 13 is a perspective view illustrating a movable unit according to the first embodiment of the present invention;

FIG. 14 is an exploded perspective view illustrating the movable unit according to the first embodiment of the present invention;

FIG. 15 is a perspective view illustrating the movable plate according to the first embodiment of the present invention;

FIG. 16 is a perspective view illustrating the movable unit in which the movable plate is removed according to the first embodiment of the present invention;

FIG. 17 is a diagram for describing a Digital Micromirror Device (DMD) holding structure of the movable unit according to the first embodiment of the present invention;

FIGS. 18A to 18D are diagrams illustrating assembly adjustment when the embodiment is not applied (related art);

FIGS. 19A to 19E are diagrams illustrating an example of assembly adjustment according to the first embodiment of the present invention;

FIGS. 20A and 20B are diagrams illustrating an example of a configuration of an adjustment device according to the first embodiment of the present invention;

FIGS. 21A to 21C are diagrams illustrating an example of assembly adjustment by the adjustment device according to the first embodiment of the present invention; and

FIG. 22 is a flowchart illustrating an example of an assembly adjustment method according to the first embodiment of the present invention.

### DETAILED DESCRIPTION OF THE PREFERRED EMBODIMENTS

In the apparatus disclosed in Patent Document 1, the appearances of the plural plate members are the same, except for the thickness, and, therefore, it has been difficult to visually recognize the difference in the thickness between the plate members in units of 0.1 mm, and there have been cases where it is difficult to efficiently adjust the distance, etc., between the illumination unit and the projection optical unit, by visual recognition.

A problem to be addressed by an embodiment of the present invention is to make it possible to visually recognize the difference in thickness between spacers such as plate members disposed between an illumination unit and an image display unit or between an illumination unit and a projection optical unit.

Embodiments of the present invention will be described by referring to the accompanying drawings.

In the specification and drawings of the embodiments, the elements having substantially the same functions are denoted by the same reference numerals, and overlapping descriptions are omitted.

### First Embodiment

### <Configuration of Image Projection Apparatus-First Embodiment>

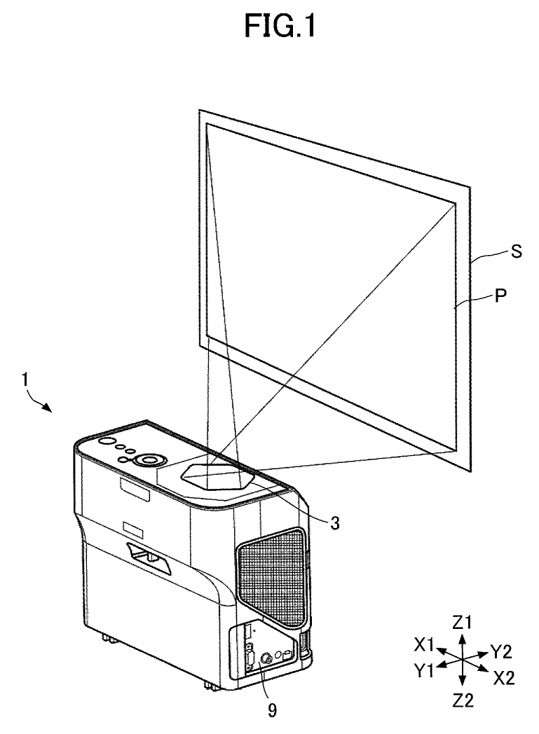

FIG. 1 is a diagram illustrating a projector 1 according to a first embodiment.

The projector 1 is an example of an image projection apparatus, including an exit window 3 and an external interface (I/F) 9, and an optical engine for generating projection images is provided in the projector 1. In the projector 1, when image data is transmitted from, for example, a personal computer or a digital camera connected to the external I/F 9, the optical engine generates a projection image based on the transmitted image data, and the projector 1 projects the projection image onto a screen S from the exit window 3, as illustrated in FIG. 1.

Note that in the following drawings, the X1X2 direction is the width direction of the projector 1, the Y1Y2 direction is the depth direction of the projector 1, and the Z1Z2 direction is the height direction of the projector 1. Furthermore, in the following description, there may be cases where the exit window 3 side of the projector 1 is described as being upward, and the side opposite to the exit window 3 is described as being downward.

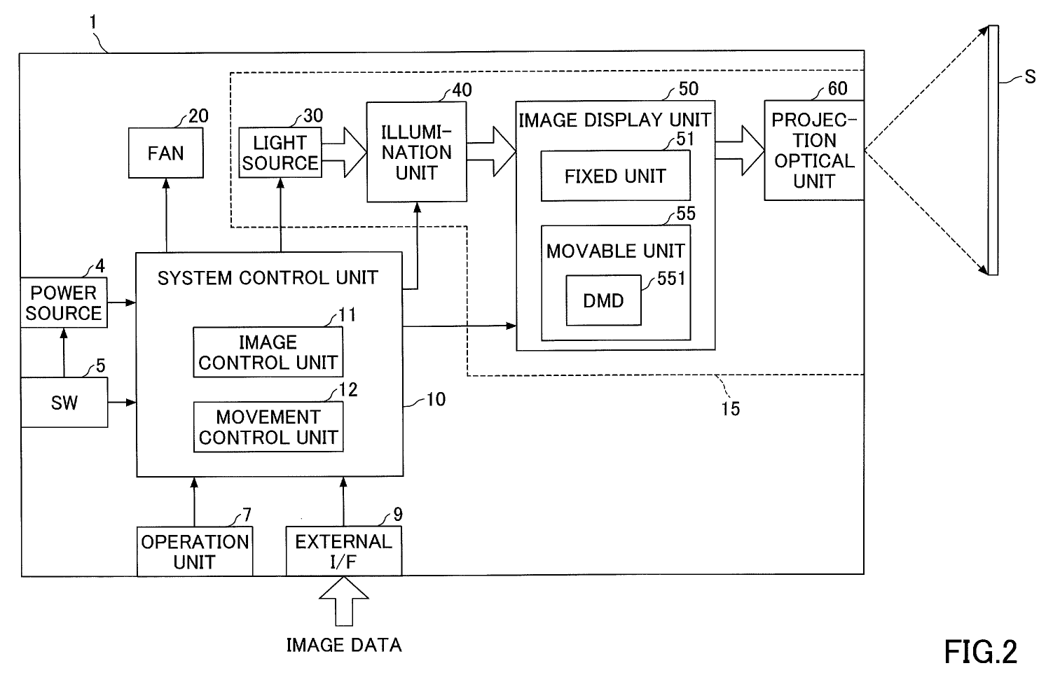

FIG. 2 is a block diagram illustrating a functional configuration of the projector 1 according to the present embodiment.

As illustrated in FIG. 2, the projector 1 includes a power source 4, a main switch SW 5, an operation unit 7, the external I/F 9, a system control unit 10, a fan 20, and an optical engine 15.

The power source 4 is connected to a commercial power source, and converts the voltage and frequency for the internal circuit of the projector 1, and supplies power to the system control unit 10, the fan 20, and the optical engine 15, etc.

The main switch SW 5 is used for turning ON/OFF the projector 1, by the user. When the main switch SW 5 is turned on while the power source 4 is connected to a commercial power source via a power cord, etc., the power source 4 starts supplying power to the respective units of the projector 1. When the main switch SW 5 is turned off, the power source 4 stops supplying power to the respective units of the projector 1.

The operation unit 7 includes buttons, etc., for accepting various operations by the user, and is provided, for example, on the top surface of the projector 1. The operation unit 7 accepts operations by the user such as adjusting the size, the color tone, and the focus of a projection image. The user operation accepted by the operation unit 7 is sent to the system control unit 10.

The external I/F 9 includes a connection terminal to be connected to, for example, a personal computer or a digital camera, etc., and outputs, to the system control unit 10, image data transmitted from the connected device.

The system control unit 10 includes an image control unit 11 and a movement control unit 12. The system control unit 10 includes, for example, a central processing unit (CPU), a read-only memory (ROM), and a random access memory (RAM), etc. The CPU executes programs stored in the ROM in cooperation with the RAM, thereby implementing functions of the respective units.

The image control unit 11 is an example of an image control means, and based on image data input from the external I/F 9, the image control unit 11 controls a digital micromirror device (hereinafter referred to simply as “DMD”) 551 provided in an image display unit 50 of the optical engine 15, to generate an image to be projected on the screen S.

The movement control unit 12 is an example of a movement control means, and moves a movable unit 55 that is movably provided in the image display unit 50, and controls the position of the DMD 551 provided in the movable unit 55.

The fan 20 is rotated under the control of the system control unit 10 to cool a light source 30 of the optical engine 15.

The optical engine 15 includes the light source 30, an illumination unit 40, the image display unit 50, and a projection optical unit 60, and is controlled by the system control unit 10 to project an image on the screen S.

The light source 30 is, for example, a mercury high pressure lamp, a xenon lamp, or a light emitting diode (LED), etc., and is controlled by the system control unit 10 to irradiate the illumination unit 40 with light.

The illumination unit 40 includes, for example, a color wheel, a light tunnel, and a relay lens, etc., and guides the light emitted from the light source 30 to the DMD 551 provided in the image display unit 50.

The image display unit 50 includes a fixed unit 51 fixedly supported, and the movable unit 55 provided so as to be movable with respect to the fixed unit 51. The movable unit 55 includes the DMD 551, and the position of the movable unit 55 with respect to the fixed unit 51 is controlled by the movement control unit 12 of the system control unit 10. The DMD 551 is an example of an image generating means, which is controlled by the image control unit 11 of the system control unit 10, and modulates the light guided by the illumination unit 40, to generate a projection image.

The projection optical unit 60 includes, for example, a plurality of projection lenses and mirrors, etc., and enlarges an image generated by the DMD 551 of the image display unit 50, and projects the image on the screen S.

### <Configuration of Optical Engine-First Embodiment>

Next, the configuration of each unit of the optical engine 15 of the projector 1 will be described.

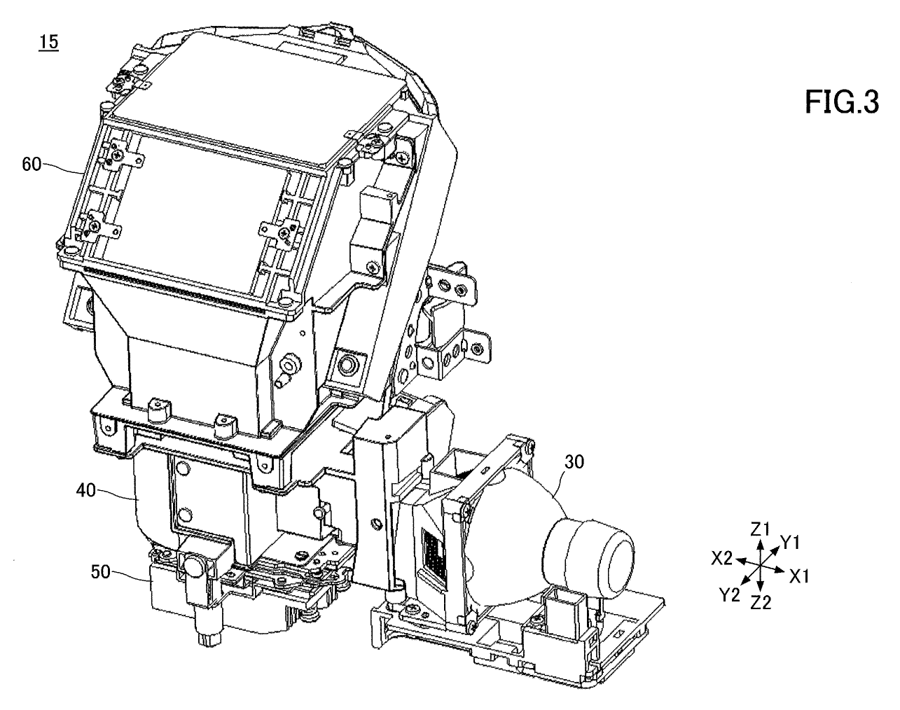

FIG. 3 is a perspective view illustrating the optical engine 15 according to the present embodiment. As illustrated in FIG. 3, the optical engine 15 includes the light source 30, the illumination unit 40, the image display unit 50, and the projection optical unit 60, and is provided inside the projector 1.

The light source 30 is provided on the side surface of the illumination unit 40, and emits light in the X2 direction. The illumination unit 40 guides the light emitted from the light source 30 to the image display unit 50 provided on the lower part. The image display unit 50 generates a projection image by using the light guided by the illumination unit 40. The projection optical unit 60 is provided above the illumination unit 40, and projects the projection image generated by the image display unit 50, to the outside of the projector 1.

Note that the optical engine 15 of the present embodiment is configured to project an image upward by using the light emitted from the light source 30; however, the optical engine 15 may be configured to project an image in the horizontal direction.

### [Illumination Unit-First Embodiment]

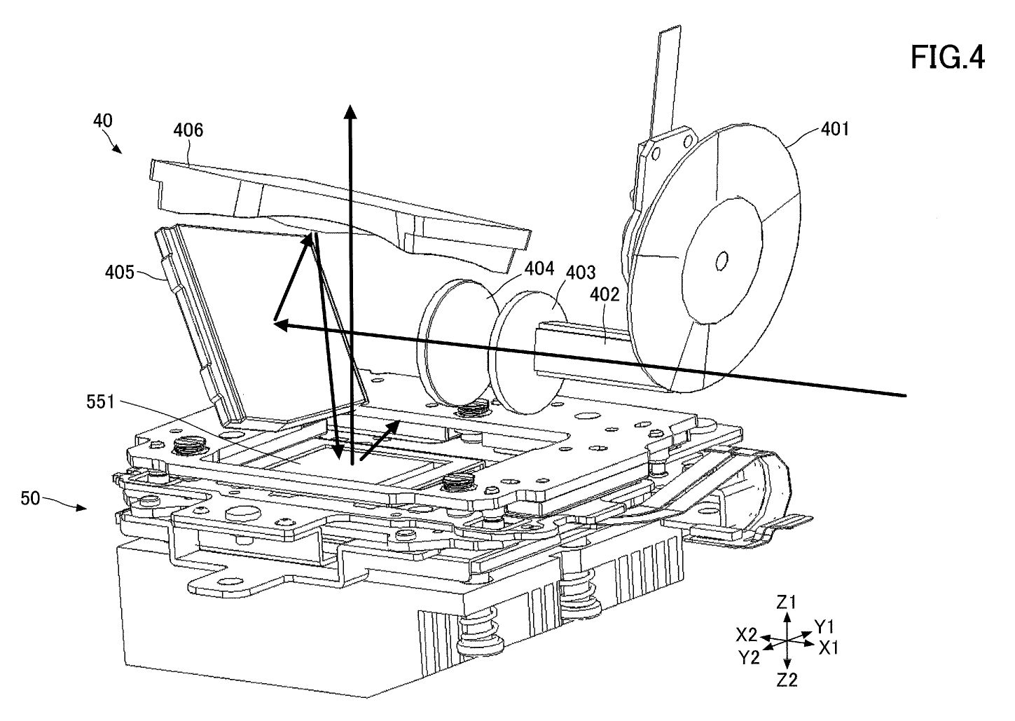

FIG. 4 is a diagram illustrating the illumination unit 40 according to the present embodiment.

As illustrated in FIG. 4, the illumination unit 40 includes a color wheel 401, a light tunnel 402, relay lenses 403 and 404, a cylinder mirror 405, and a concave mirror 406.

The color wheel 401 is, for example, a disk provided with filters of the respective colors of R (red), G (green), and B (blue) in different portions in the circumferential direction. By rotating the color wheel 401 at high speed, the light emitted from the light source 30 is time-divided into the RGB colors.

The light tunnel 402 is formed into a rectangular tube shape by bonding glass plates, etc. The light tunnel 402 multiply reflects the light of each of the RGB colors transmitted through the color wheel 401, to make the brightness distribution uniform, and guides the light to the relay lenses 403 and 404.

The relay lenses 403 and 404 collect light emitted from the light tunnel 402, while correcting the axial chromatic aberration of the light.

The cylinder mirror 405 and the concave mirror 406 reflect the light emitted from the relay lenses 403 and 404, onto the DMD 551 provided in the image display unit 50. The DMD 551 modulates the reflected light from the concave mirror 406, to generate a projection image.

### [Projection Optical Unit-First Embodiment]

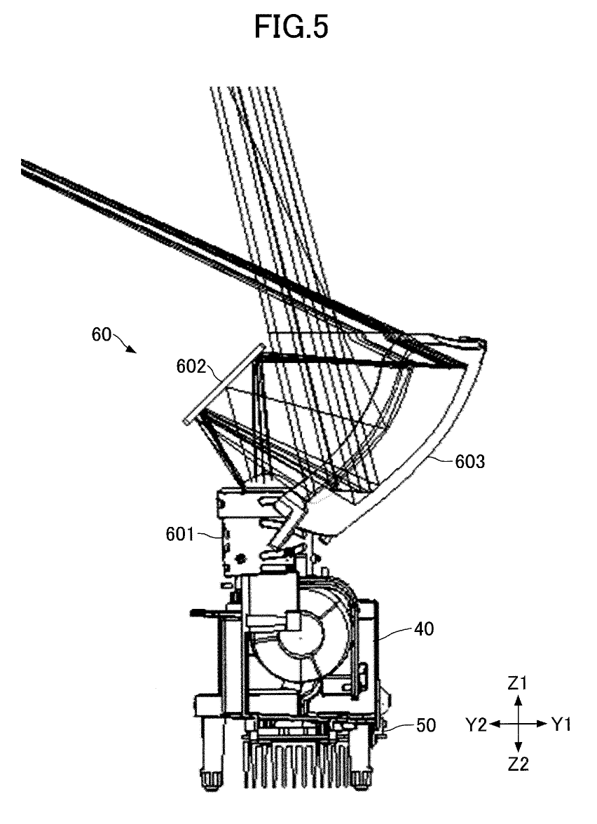

FIG. 5 is a diagram illustrating the internal configuration of the projection optical unit 60 according to the present embodiment.

As illustrated in FIG. 5, in the projection optical unit 60, a projection lens 601, a reflecting mirror 602, and a curved mirror 603 are provided inside a case.

The projection lens 601 includes a plurality of lenses, and focuses a projection image generated by the DMD 551 of the image display unit 50, on the reflecting mirror 602. The reflecting mirror 602 and the curved mirror 603 reflect the focused projection image so as to enlarge the focused projection image, and project the focused projection image onto the screen S, etc., outside the projector 1.

### [Image Display Unit-First Embodiment]

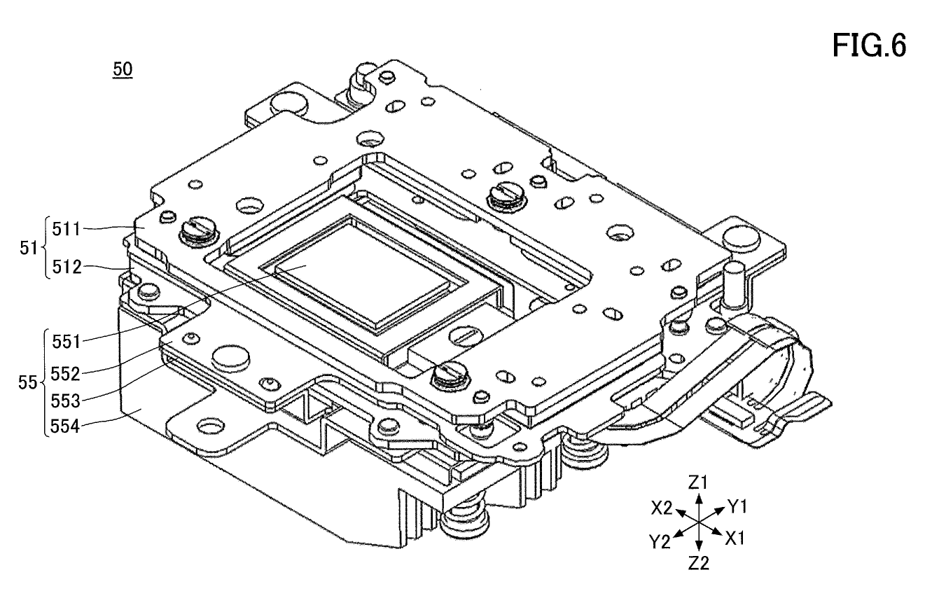

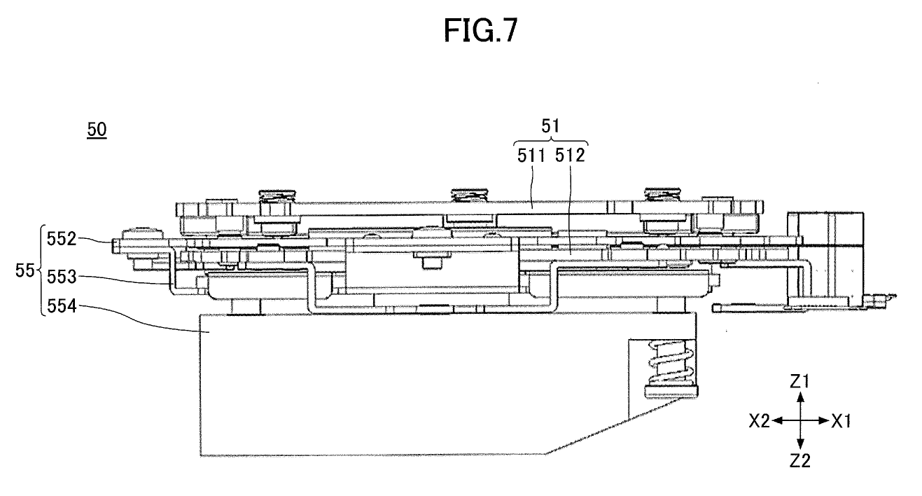

FIG. 6 is a perspective view illustrating the image display unit 50 according to the present embodiment. FIG. 7 is a side view illustrating the image display unit 50 according to the present embodiment.

As illustrated in FIGS. 6 and 7, the image display unit 50 includes the fixed unit 51 that is fixedly supported, and the movable unit 55 provided so as to be movable with respect to the fixed unit 51.

The fixed unit 51 includes a top plate 511 as a first fixed plate and a base plate 512 as a second fixed plate. In the fixed unit 51, the top plate 511 and the base plate 512 are provided in parallel via a predetermined gap, and are fixed to the lower part of the illumination unit 40.

The movable unit 55 includes the DMD 551, a movable plate 552 as a first movable plate, a coupling plate 553 as a second movable plate, and a heat sink 554, and is movably supported by the fixed unit 51.

The movable plate 552 is provided between the top plate 511 and the base plate 512 of the fixed unit 51, and is supported by the fixed unit 51 so as to be movable in a direction parallel to the top plate 511 and the base plate 512 and in a direction parallel to the surface of the movable plate 552.

The coupling plate 553 is fixed to the movable plate 552 with the base plate 512 of the fixed unit 51 interposed therebetween. The DMD 551 is fixedly provided on the upper surface side of the coupling plate 553, and the heat sink 554 is fixed to the lower surface side of the coupling plate 553. By being fixed to the movable plate 552, the coupling plate 553 is movably supported by the fixed unit 51 together with the movable plate 552, the DMD 551, and the heat sink 554.

The DMD 551 is provided on the surface of the coupling plate 553 facing the movable plate 552, and is provided so as to be movable together with the movable plate 552 and the coupling plate 553. The DMD 551 has an image generation surface on which a plurality of movable micromirrors is arranged in a lattice pattern. Each micromirror of the DMD 551 is provided so that the mirror surface thereof can be tilted around a torsion axis, and can be driven ON/OFF based on image signals transmitted from the image control unit 11 of the system control unit 10.

For example, when the micromirror is “ON”, the tilt angle of the micromirror is controlled so as to reflect the light from the light source 30 to the projection optical unit 60. Furthermore, when the micromirror is “OFF”, for example, the tilt angle of the micromirror is controlled to be in a direction so as to reflect the light from the light source 30 toward an OFF light plate (not illustrated).

In this manner, in the DMD 551, the tilt angle of each micromirror is controlled by the image signals transmitted from the image control unit 11, and the DMD 551 modulates the light emitted from the light source 30 and passed through the illumination unit 40, to generate a projection image.

The heat sink 554 is an example of a heat radiating means, and at least a part thereof is provided so as to be in contact with the DMD 551. The heat sink 554 is provided together with the DMD 551 on the movably supported coupling plate 553, and, therefore, the heat sink 554 can come into contact with the DMD 551 and efficiently cool the DMD 551. With such a configuration, in the projector 1 according to the present embodiment, the heat sink 554 reduces the temperature rise of the DMD 551, and the occurrence of defects such as malfunctions or failures, caused by the temperature rise of the DMD 551, etc., is reduced.

### (Fixed Unit-First Embodiment)

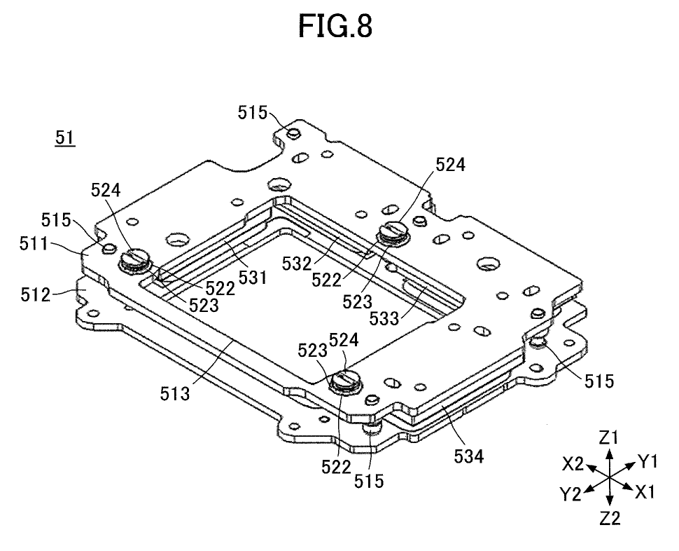

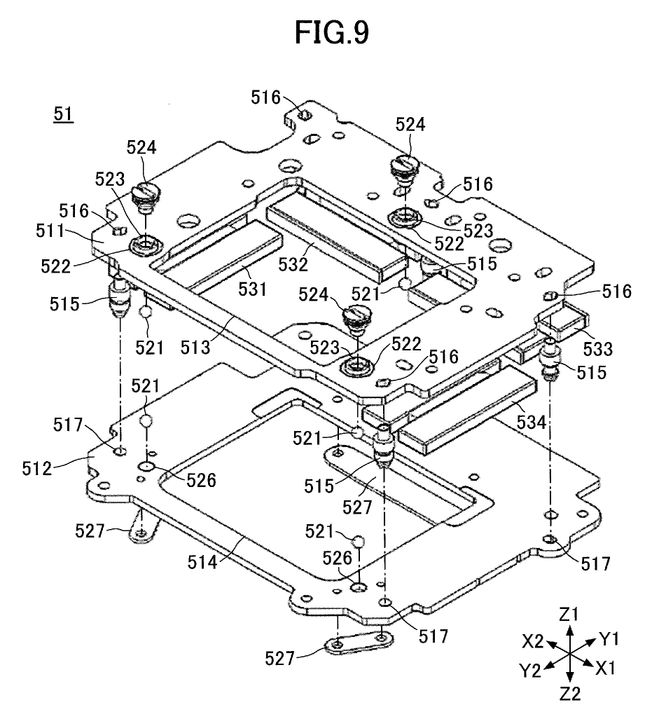

FIG. 8 is a perspective view illustrating the fixed unit 51 according to the present embodiment. Furthermore, FIG. 9 is an exploded perspective view illustrating the fixed unit 51 according to the present embodiment.

As illustrated in FIGS. 8 and 9, the fixed unit 51 includes the top plate 511 and the base plate 512.

The top plate 511 and the base plate 512 are formed of flat plate members, and center holes 513 and 514 are provided at positions corresponding to the DMD 551 of the movable unit 55. Furthermore, the top plate 511 and the base plate 512 are provided in parallel via a predetermined gap, by a plurality of support columns 515.

As illustrated in FIG. 9, the upper end portion of the support column 515 is press-fit into a support hole 516 formed in the top plate 511, and the lower end portion of the support column 515 where a male screw groove is formed, is inserted into a support hole 517 formed in the base plate 512. The support column 515 forms a certain gap between the top plate 511 and the base plate 512, and supports the top plate 511 and the base plate 512 in parallel.

Furthermore, a plurality of support holes 522 and 526 are formed in the top plate 511 and the base plate 512 so as to rotatably hold support spherical bodies 521.

In the support hole 522 of the top plate 511, a cylindrical holding member 523 having a female screw groove formed on the inner peripheral surface, is inserted. The holding member 523 rotatably holds the support spherical body 521, and a position adjusting screw 524 is inserted from above. The support hole 526 of the base plate 512 is closed at the lower end side by a lid member 527 and rotatably holds the support spherical body 521.

The support spherical bodies 521 rotatably held in the support holes 522 and 526 of the top plate 511 and the base plate 512, respectively, contact the movable plate 552 provided between the top plate 511 and the base plate 512, thereby movably supporting the movable plate 552.

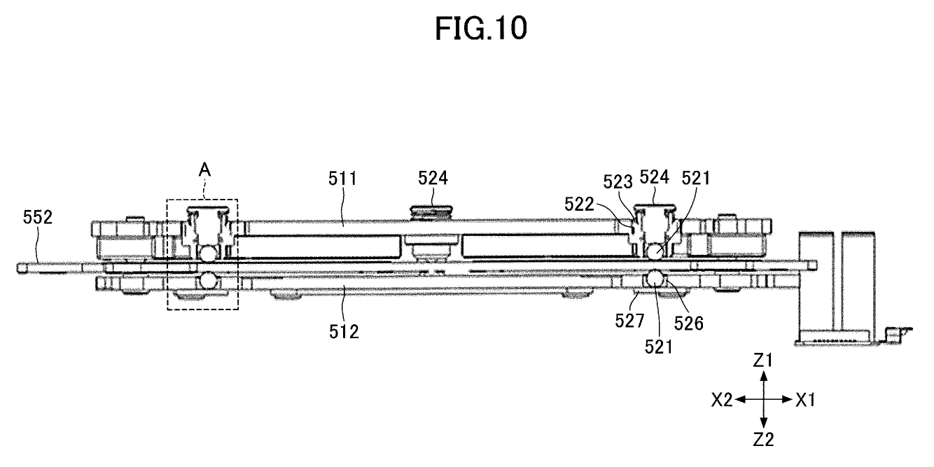

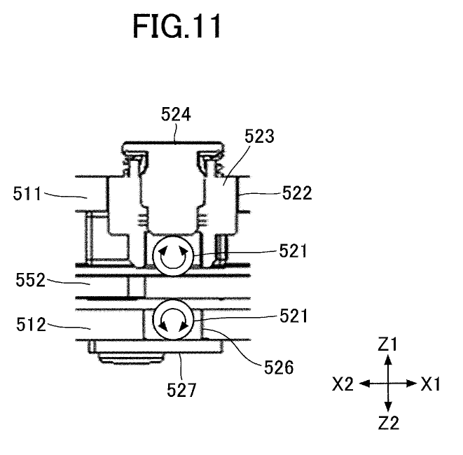

FIG. 10 is a diagram for describing the supporting structure of the movable plate 552 by the fixed unit 51 according to the present embodiment. FIG. 11 is a partially enlarged view illustrating a schematic configuration of a portion A indicated in FIG. 10.

As illustrated in FIGS. 10 and 11, in the top plate 511, the support spherical body 521 is rotatably held by the holding member 523 inserted into the support hole 522. Furthermore, in the base plate 512, the support spherical body 521 is rotatably held by the support hole 526 whose lower end side is closed by the lid member 527.

Each support spherical body 521 is held so that at least a part thereof protrudes from the support holes 522 and 526, and contacts and supports the movable plate 552 provided between the top plate 511 and the base plate 512. The movable plate 552 is supported from both sides by a plurality of rotatably provided support spherical bodies 521 so as to be movable in parallel to the top plate 511 and the base plate 512 and in a direction parallel to the surface of the movable plate 552.

Furthermore, the amount of protrusion, from the lower end of the holding member 523, of the support spherical body 521 provided on the top plate 511 side, varies according to the position of the position adjusting screw 524 that contacts the support spherical body 521 on the side opposite to the movable plate 552. For example, when the position adjusting screw 524 is displaced in the Z1 direction, the protrusion amount of the support spherical body 521 decreases, and the gap between the top plate 511 and the movable plate 552 decreases. Also, for example, when the position adjusting screw 524 is displaced in the Z2 direction, the protrusion amount of the support spherical body 521 increases, and the gap between the top plate 511 and the movable plate 552 increases.

In this way, by changing the amount of protrusion of the support spherical body 521 by using the position adjusting screw 524, the gap between the top plate 511 and the movable plate 552 can be appropriately adjusted.

Furthermore, as illustrated in FIGS. 8 and 9, on the surface of the top plate 511 facing the base plate 512, magnets 531, 532, 533, and 534 are provided.

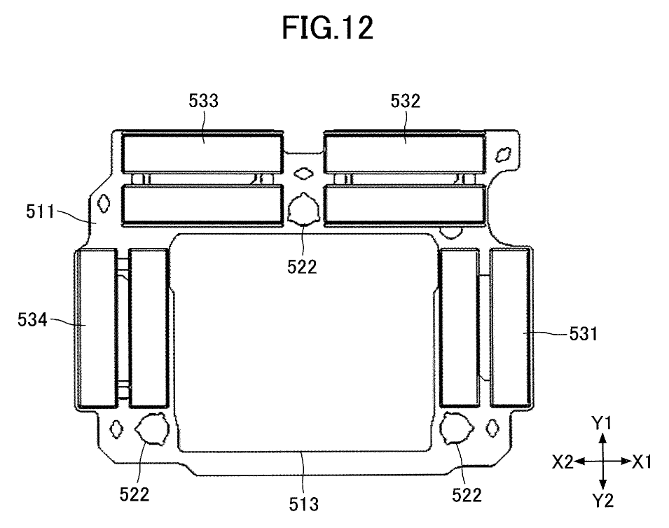

FIG. 12 is a bottom view illustrating the top plate 511 according to the present embodiment. As illustrated in FIG. 12, the magnets 531, 532, 533, and 534 are provided on the surface of the top plate 511 facing the base plate 512.

The magnets 531, 532, 533, and 534 are provided at four positions so as to surround the center hole 513 of the top plate 511. Each of the magnets 531, 532, 533, and 534 is formed of two rectangular parallelepiped magnets arranged so that their longitudinal directions are parallel to each other, and form a magnetic field extending to the movable plate 552.

The magnets 531, 532, 533, and 534 form a moving means for moving the movable plate 552 by coils provided on the upper surface of the movable plate 552 and opposite the magnets 531, 532, 533, and 534, respectively.

Note that the numbers and the positions of the support columns 515 and the support spherical bodies 521 provided in the fixed unit 51 described above, are not limited to the configuration illustrated in the present embodiment, as long as these elements can movably support the movable plate 552.

### (Movable Unit-First Embodiment)

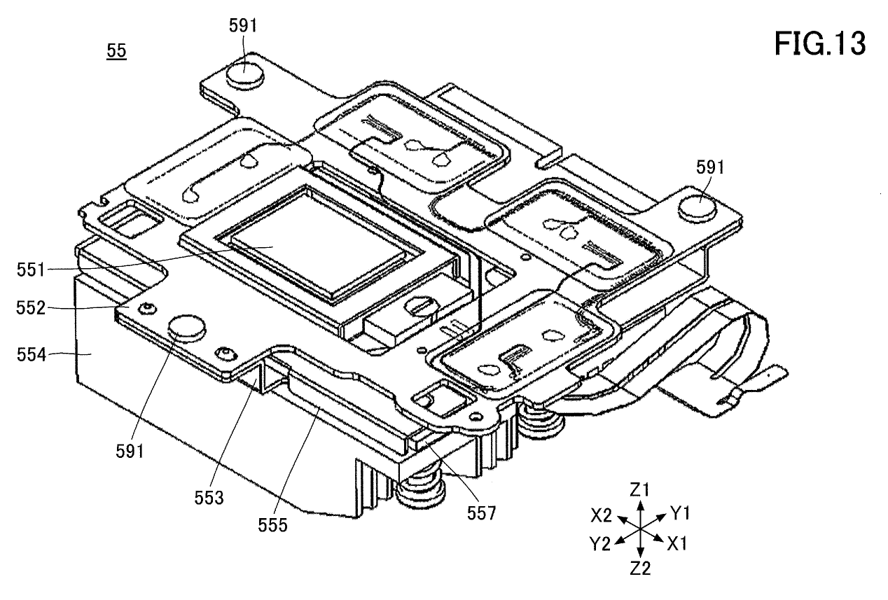

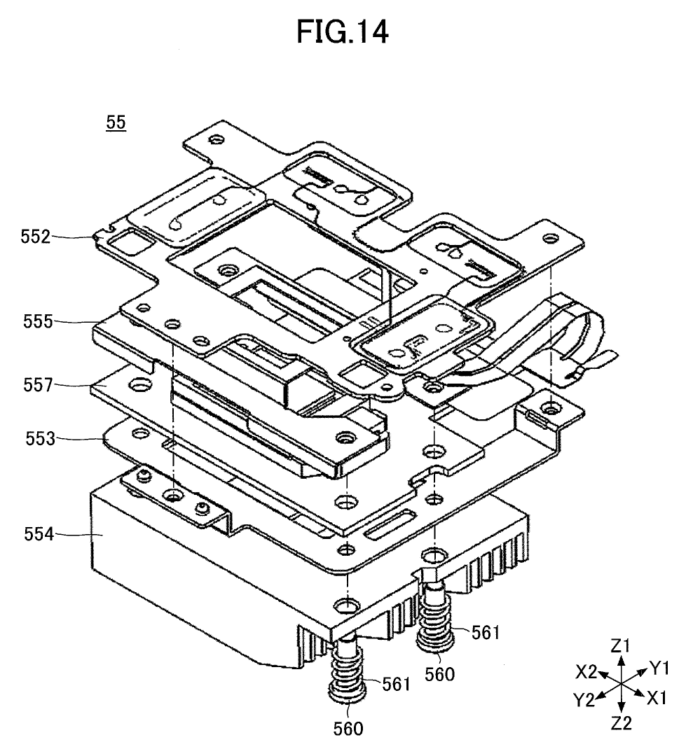

FIG. 13 is a perspective view illustrating the movable unit 55 according to the present embodiment. Furthermore, FIG. 14 is an exploded perspective view illustrating the movable unit 55 according to the present embodiment.

As illustrated in FIGS. 13 and 14, the movable unit 55 includes the DMD 551, the movable plate 552, the coupling plate 553, the heat sink 554, a holding member 555, and a DMD substrate 557, and is movably supported with respect to the fixed unit 51.

As described above, the movable plate 552 is provided between the top plate 511 and the base plate 512 of the fixed unit 51, and is supported so as to be movable in a direction parallel to the surface of the movable plate 552 by a plurality of support spherical bodies 521.

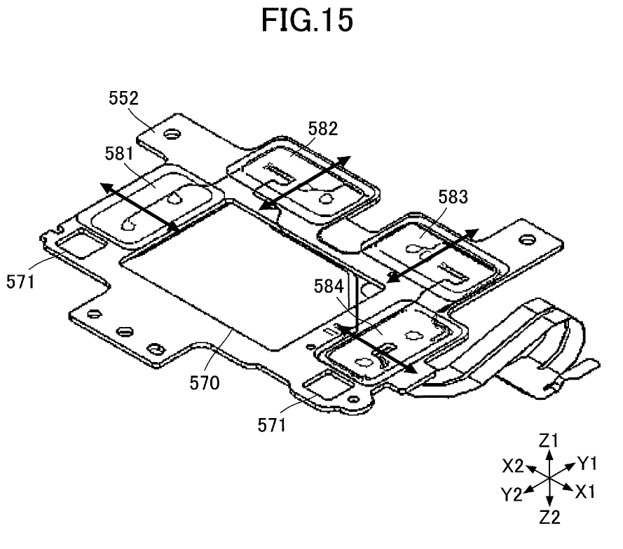

FIG. 15 is a perspective view illustrating the movable plate 552 according to the present embodiment.

As illustrated in FIG. 15, the movable plate 552 is formed of a flat plate member, and has a center hole 570 at a position corresponding to the DMD 551 provided on the DMD substrate 557, and coils 581, 582, 583, and 584 are provided around the center hole 570.

The coils 581, 582, 583, and 584 are formed by winding electric wires around axes parallel to the Z1Z2 direction, respectively, and are provided in recesses formed on the surface of the movable plate 552 facing the top plate 511, and are covered by covers. The coils 581, 582, 583, and 584 form a moving means for moving the movable plate 552, together with the magnets 531, 532, 533, and 534 of the top plate 511, respectively.

The magnets 531, 532, 533, and 534 of the top plate 511 and the coils 581, 582, 583, and 584 of the movable plate 552 are provided at positions facing each other in a state where the movable unit 55 is supported by the fixed unit 51. When an electric current is passed through the coils 581, 582, 583, and 584, a Lorentz force serving as a driving force for moving the movable plate 552 is generated by a magnetic field formed by the magnets 531, 532, 533, and 534.

The movable plate 552 receives a Lorentz force as a driving force generated between the magnets 531, 532, 533, and 534 and the coils 581, 582, 583, and 584, and is displaced linearly or rotatably in the XY plane with respect to the fixed unit 51.

The magnitude and direction of the electric current flowing through the coils 581, 582, 583, and 584 are controlled by the movement control unit 12 of the system control unit 10. The movement control unit 12 controls the movement (rotation) direction, the movement amount, and the rotation angle, etc., of the movable plate 552 according to the magnitude and direction of the electric current flowing through the coils 581, 582, 583, and 584.

In the present embodiment, as a first driving means, the coil 581 and the magnet 531, and the coil 584 and the magnet 534 are provided opposite to each other in the X1X2 direction. When an electric current flows through the coil 581 and the coil 584, a Lorentz force in the X1 direction or X2 is generated as illustrated in FIG. 15. The movable plate 552 moves in the X1 direction or the X2 direction due to the Lorentz force generated in the coil 581 and the magnet 531, and the coil 584 and the magnet 534.

Furthermore, in the present embodiment, as a second driving means, the coil 582 and the magnet 532, and the coil 583 and the magnet 533 are provided side by side in the X1X2 direction; and the magnet 532 and the magnet 533, and the magnet 531 and the magnet 534, are disposed so that their longitudinal directions are perpendicular to each other. In such a configuration, when an electric current flows through the coil 582 and the coil 583, a Lorentz force in the Y1 direction or the Y2 direction is generated as illustrated in FIG. 15.

The movable plate 552 moves in the Y1 direction or the Y2 direction by the Lorentz force generated in the coil 582 and the magnet 532, and the coil 583 and the magnet 533. Furthermore, the movable plate 552 is displaced so as to rotate in the XY plane by Lorentz forces generated in opposite directions between the coil 582 and the magnet 532, and the coil 583 and the magnet 533.

For example, when an electric current flows so that a Lorentz force in the Y1 direction is generated in the coil 582 and the magnet 532, and a Lorentz force in the Y2 direction is generated in the coil 583 and the magnet 533, the movable plate 552 is displaced so as to rotate in a clockwise direction as viewed from the top. Furthermore, when an electric current flows so that a Lorentz force in the Y2 direction is generated in the coil 582 and the magnet 532, and a Lorentz force in the Y1 direction is generated in the coil 583 and the magnet 533, the movable plate 552 is displaced so as to rotate in a counterclockwise direction as viewed from the top.

A movable range limiting hole 571 is provided in the movable plate 552 at a position corresponding to the support column 515 of the fixed unit 51. In the movable range limiting hole 571, the support column 515 of the fixed unit 51 is inserted, so that the movable range of the movable plate 552 is limited, for example, when the movable plate 552 moves largely due to vibration or some abnormality, and contacts the support column 515.

As described above, in the present embodiment, the movement control unit 12 of the system control unit 10 controls the magnitude and direction of an electric current flowing through the coils 581, 582, 583, and 584, so that the movable plate 552 can be moved to any position.

Note that the number and position, etc., of the magnets 531, 532, 533, and 534 and the coils 581, 582, 583, and 584 as the moving means may be different from those of the present embodiment, as long as the movable plate 552 can be moved to any position. For example, the magnet as the moving means may be provided on the top surface of the top plate 511 or may be provided on either surface of the base plate 512. Furthermore, for example, a magnet may be provided on the movable plate 552 and a coil may be provided on the top plate 511 or the base plate 512.

Furthermore, the number, the position, and the shape, etc., of the movable range limiting hole 571 may be different from those of the present embodiment. For example, the number of movable range limiting holes 571 may be one or plural. Furthermore, the movable range limiting hole 571 may have a different shape from the present embodiment, for example, a rectangular shape, or a circular shape, etc.

As illustrated in FIG. 13, the coupling plate 553 is fixed to the lower surface side (the side facing the base plate 512) of the movable plate 552 movably supported by the fixed unit 51. The coupling plate 553 is formed of a flat plate member, has a center hole at a position corresponding to the DMD 551, and the surrounding bending portions are fixed to the lower surface of the movable plate 552 by three screws 591.

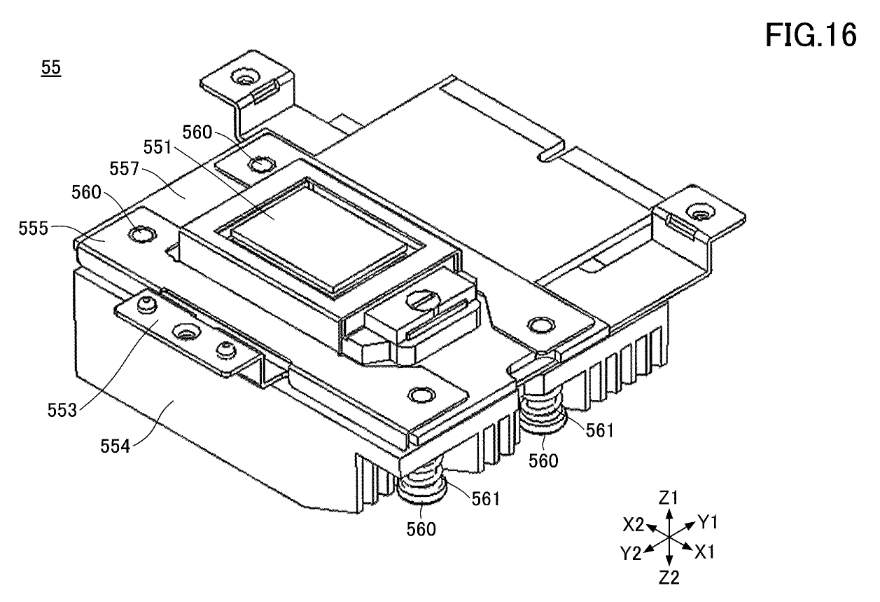

FIG. 16 is a perspective view illustrating the movable unit 55, with the movable plate 552 removed.

As illustrated in FIG. 16, the coupling plate 553 is provided with the DMD 551 on the upper surface side and the heat sink 554 on the lower surface side. By being fixed to the movable plate 552, the coupling plate 553 is movably provided with respect to the fixed unit 51 in accordance with the movement of the movable plate 552, together with the DMD 551 and the heat sink 554.

The DMD 551 is provided on the DMD substrate 557, and is fixed to the coupling plate 553 such that the DMD substrate 557 is sandwiched between the holding member 555 and the coupling plate 553. As illustrated in FIGS. 14 and 16, the holding member 555, the DMD substrate 557, the coupling plate 553, and the heat sink 554 are stacked and fixed to each other by stepped screws 560 as fixing members and springs 561 as pressing means.

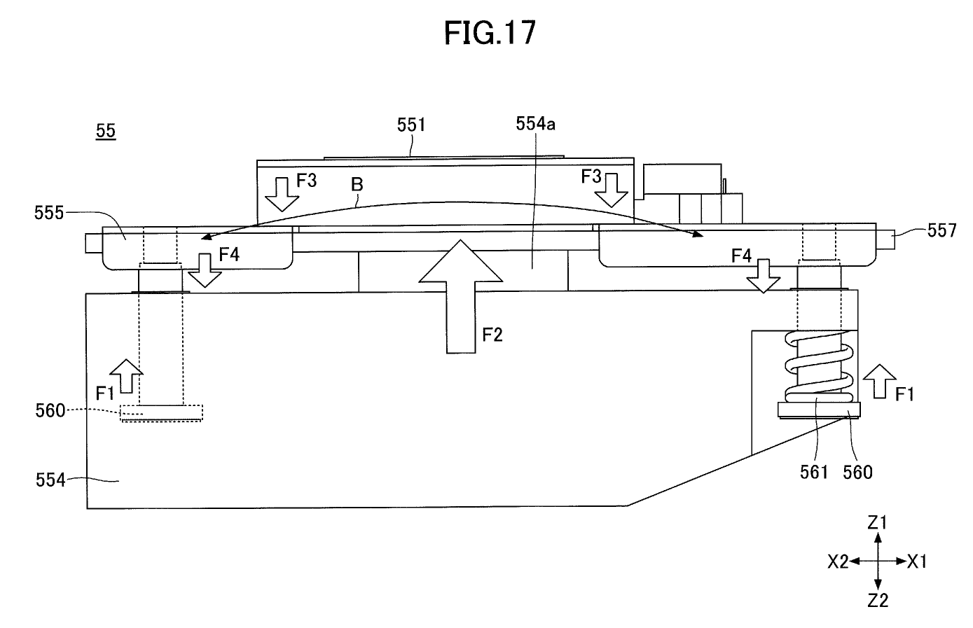

FIG. 17 is a view for describing the DMD holding structure of the movable unit 55 according to the present embodiment. FIG. 17 is a side view of the movable unit 55, and the movable plate 552 and the coupling plate 553 are not illustrated.

As illustrated in FIG. 17, the heat sink 554 has a protruding portion 554a that is in contact with the lower surface of the DMD 551 from a through hole that is provided in the DMD substrate 557, in a state of being fixed to the coupling plate 553. Note that the protruding portion 554a of the heat sink 554 may be provided on the lower surface of the DMD substrate 557 so as to be in contact with a position corresponding to the DMD 551.

Furthermore, in order to enhance the cooling effect of the DMD 551, an elastically deformable heat transfer sheet may be provided between the protruding portion 554a of the heat sink 554 and the DMD 551. The thermal conductivity between the protruding portion 554a of the heat sink 554 and the DMD 551 will be improved by the heat transfer sheet, and the cooling effect of the DMD 551 by the heat sink 554 will be improved.

As described above, the holding member 555, the DMD substrate 557, and the heat sink 554 are stacked and fixed to each other by the stepped screws 560 and the springs 561. When the stepped screw 560 is tightened, the spring 561 is compressed in the Z1Z2 direction, and a force F1 in the Z1 direction illustrated in FIG. 17, is generated from the spring 561. Due to the force F1 generated from the spring 561, the heat sink 554 is pressed against the DMD 551, by a force F2 in the Z1 direction.

In the present embodiment, the stepped screws 560 and the springs 561 are provided at four positions, and the force F2 applied to the heat sink 554 is equal to a combination of the forces F1 generated in the four springs 561. Furthermore, the force F2 from the heat sink 554 acts on the holding member 555 holding the DMD substrate 557 on which the DMD 551 is provided. As a result, a reaction force F3 in the Z2 direction, corresponding to the force F2 from the heat sink 554, is generated in the holding member 555, and the DMD substrate 557 can be held between the holding member 555 and the coupling plate 553.

A force F4 in the Z2 direction acts on the stepped screw 560 and the spring 561, from the force F3 generated in the holding member 555. The spring 561 is provided at four positions, and, therefore, the force F4 acting on each of the springs 561 corresponds to one fourth of the force F3 generated in the holding member 555, and is equal to the force F1.

Furthermore, the holding member 555 is a member that can bend as indicated by an arrow B in FIG. 17, and is formed to have a shape of a plate spring. The holding member 555 is pressed and bent by the protruding portion 554a of the heat sink 554, and generates a force to push back the heat sink 554 in the Z2 direction, whereby the contact between the DMD 551 and the heat sink 554 can be more firmly maintained.

As described above, in the movable unit 55, the movable plate 552, and the coupling plate 553 including the DMD 551 and the heat sink 554, are movably supported by the fixed unit 51. The position of the movable unit 55 is controlled by the movement control unit 12 of the system control unit 10. Furthermore, the movable unit 55 is provided with the heat sink 554 that contacts the DMD 551, thereby preventing the occurrence of defects such as malfunctions or failure caused by the temperature rise of the DMD 551.

### <Image Projection-First Embodiment>

As described above, in the projector 1 of the present embodiment, the DMD 551 for generating a projection image is provided in the movable unit 55, and the position of the DMD 551 is controlled, together with the movable unit 55, by the movement control unit 12 of the system control unit 10.

For example, the movement control unit 12 controls the position of the movable unit 55 so as to move at a high speed between a plurality of positions separated by a distance less than the arrangement interval of the plurality of micromirrors of the DMD 551, at a predetermined cycle corresponding to the frame rate at the time of image projection. At this time, the image control unit 11 transmits image signals to the DMD 551 so as to generate a projection image shifted according to each position.

For example, the movement control unit 12 reciprocally moves the DMD 551 at a predetermined cycle, between a position P1 and a position P2 that are separated by a distance less than the arrangement interval of the micromirrors of the DMD 551, in the X1X2 direction and the Y1Y2 direction. At this time, the image control unit 11 controls the DMD 551 so as to generate a projection image shifted according to each position, so that the resolution of the projection image can be made approximately twice the resolution of the DMD 551. Furthermore, by increasing the movement positions of the DMD 551, the resolution of the projection image can be set to twice or more the resolution of the DMD 551.

In this manner, the movement control unit 12 moves the DMD 551 together with the movable unit 55 at a predetermined cycle, and the image control unit 11 causes the DMD 551 to generate a projection image according to the position, and, therefore, it is possible to project an image having a resolution that is greater than or equal to the resolution of the DMD 551.

Furthermore, in the projector 1 of the present embodiment, the movement control unit 12 controls the DMD 551 to rotate together with the movable unit 55, and, therefore, it is possible to rotate the projection image without reducing the projection image. For example, in a projector in which an image generation means such as the DMD 551 is fixed, unless the projection image is reduced, it is not possible to rotate the projection image while maintaining the aspect ratio of the projection image. On the other hand, in the projector 1 of the present embodiment, the DMD 551 can be rotated, and, therefore, it is possible to adjust the tilt, etc., by rotating the projection image without reducing the projection image.

As described above, in the projector 1 of the present embodiment, the DMD 551 is configured to be movable, and, therefore, the resolution of the projection image can be increased. Furthermore, the heat sink 554 for cooling the DMD 551 is mounted on the movable unit 55 together with the DMD 551, and, therefore, it is possible to more efficiently cool the DMD 551 by contacting the DMD 551 with the heat sink 554, so that the temperature rise of the DMD 551 is reduced. Therefore, in the projector 1, defects such as malfunctions or failures caused by the temperature rise of the DMD 551, are reduced.

### (Assembly Adjustment Method-First Embodiment)

When the image projection apparatus is manufactured, the illumination unit, the image display unit, and the projection optical unit, which are respectively assembled as units, are combined together, and the optical engine in the image projection apparatus is assembled.

Parts such as the DMD and the lens forming each unit sometimes have manufacturing variations to some extent, within the tolerance range. Therefore, at the time of assembling the optical engine, the position and the focus of the projection image are adjusted for each optical engine, and the influence of the manufacturing variations of the parts is removed. In the assembly adjustment, the distance between the illumination unit and the image display unit, or the distance between the illumination unit and the projection optical unit, etc., is adjusted.

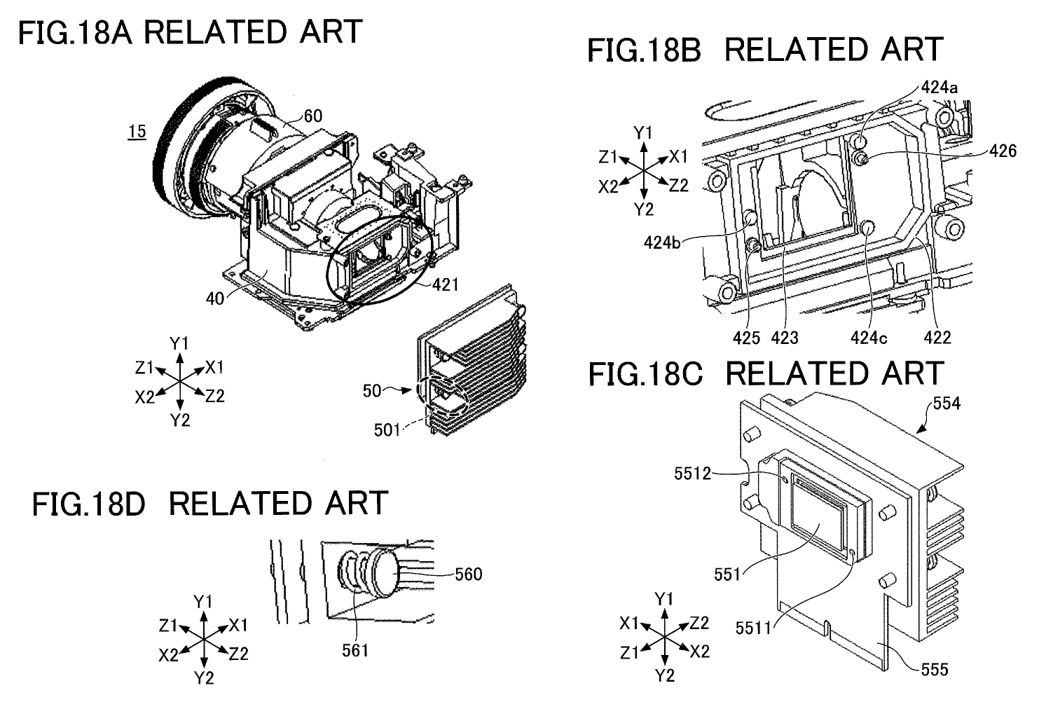

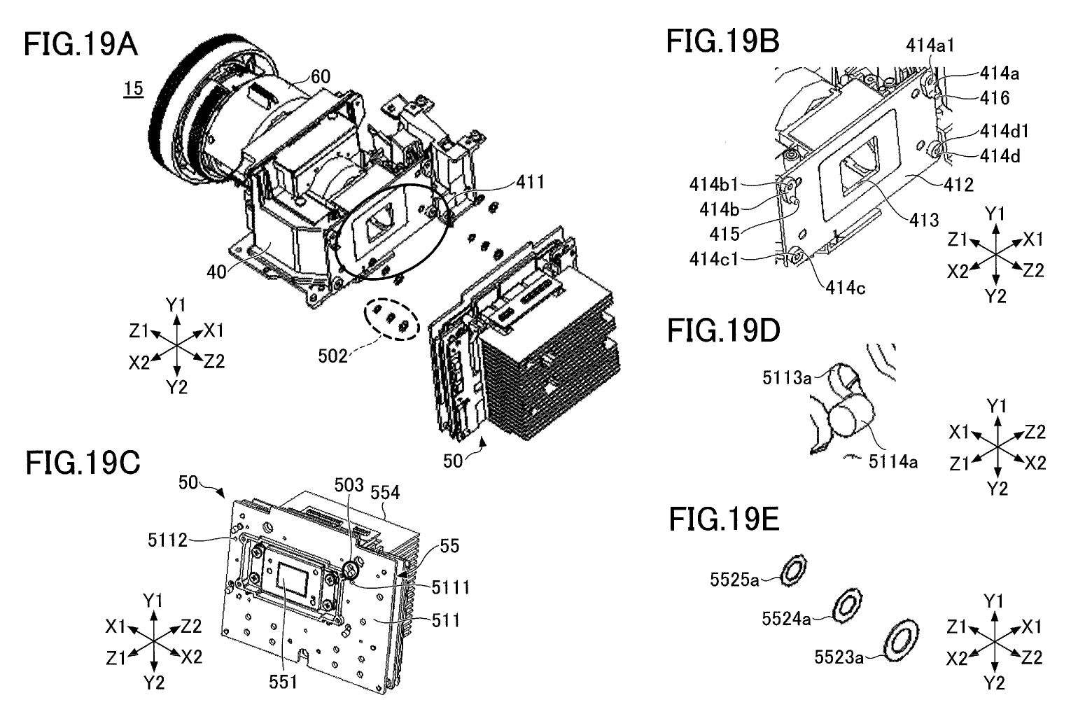

With respect to the assembly adjustment of the optical engine as described above, a case where the illumination unit and the image display unit are assembled, will be described as an example. Furthermore, for the purpose of comparison, first, the assembly adjustment in a case where the present embodiment is not applied, will be described with reference to FIGS. 18A to 18D. Then, the assembly adjustment according to the present embodiment will be described with reference to FIGS. 19A to 22.

As a matter of convenience of comparison, even for the case where the present embodiment is not applied, the units and parts, etc., having the same functions as those of the image projection apparatus 1 according to the present embodiment, are denoted by the same part numbers.

FIGS. 18A to 18D are diagrams illustrating the assembly adjustment of an optical engine in a case where the present embodiment is not applied (related art).

FIG. 18A is a perspective view illustrating the overall configuration of the optical engine 15. The optical engine 15 includes the illumination unit 40, the image display unit 50, and the projection optical unit 60. In FIG. 18A, the illumination unit 40 and the projection optical unit 60 are already assembled, and the state immediately before the image display unit 50 is assembled to the illumination unit 40, is illustrated.

The image display unit 50 is moved in the Z1 direction and assembled so that the DMD 551 of the image display unit 50 is disposed in a portion indicated by a solid line 421 of the illumination unit 40.

FIG. 18B is a diagram illustrating an enlarged part of the illumination unit 40, indicated by the solid line 421 in FIG. 18A.

As illustrated in FIG. 18B, in a casing 422 of the illumination unit 40, a rectangular opening 423 is formed at a position where the image generation surface of the DMD 551 is to be disposed, when the image display unit 50 is assembled. Furthermore, in the casing 422, around the opening 423, DMD reference surfaces 424a, 424b, and 424c, a DMD main reference shaft 425, and a DMD subordinate reference shaft 426, are formed.

The DMD reference surfaces 424a, 424b, and 424c are reference surfaces with which a part of the surface of the DMD 551 is brought into contact, when the image display unit 50 is assembled to the illumination unit 40. By bringing the DMD 551 into contact with the DMD reference surfaces, it is possible to set the distance between the illumination unit 40 and the image display unit 50 in the Z1Z2 direction, and to reduce the inclination of the illumination unit 40 and the image display unit 50.

The DMD main reference shaft 425 and the DMD subordinate reference shaft 426 are pin-shaped members to be fit into reference holes provided in the holding member of the DMD 551 when the image display unit 50 is assembled to the illumination unit 40. By fitting the shafts in the holes, the positions of the illumination unit 40 and the image display unit 50 in the X1X2 direction and the Y1Y2 direction can be set. The DMD main reference shaft 425 is the main reference shaft in setting the positions of the illumination unit 40 and the image display unit 50 in the X1X2 direction and the Y1Y2 direction.

FIG. 18C is a perspective view of the image display unit 50 illustrated in FIG. 18A as viewed in the Z2 direction. As illustrated in FIG. 18C, the image display unit 50 includes the DMD 551, the holding member 555, and the heat sink 554, etc. The DMD 551 is fixed to the holding member 555. The heat sink 554 is fixed to a surface of the holding member 555 opposite to the surface to which the DMD 551 is fixed.

In the holding member 555, a DMD main reference hole 5511 and a DMD subordinate reference hole 5512 are formed around the DMD 551. As described above, the DMD main reference shaft 425 is fit into the DMD main reference hole 5511, and the DMD subordinate reference shaft 426 is fit into the DMD subordinate reference hole 5512.

FIG. 18D is a diagram in which a portion of the image display unit 50 indicated by a broken-line circle 501 in FIG. 18A is enlarged. This part is a “screw part” for screwing and fixing the image display unit 50 to the illumination unit 40. The screw parts are provided at four positions in a plane including the X1X2 direction and the Y1Y2 direction. One of the four screw parts is enlarged in FIG. 18D.

As illustrated in FIG. 18D, the screw part is provided with the stepped screw 560 and the spring 561. The stepped screw 560 is coupled to the female screw part provided in the illumination unit via the spring 561, whereby the image display unit 50 is fixed to the illumination unit 40.

Parts such as the holding member 555 and the

DMD reference surfaces 424a, 424b, and 424c, etc., sometimes have manufacturing variations to some extent, within the tolerance range. Due to such manufacturing variations, in the configuration as described above, it is sometimes difficult to set the distance between the illumination unit 40 and the image display unit 50 in the Z1Z2 direction within a desired range, or to reduce the inclination of the illumination unit 40 and the image display unit 50 to a desired range.

Furthermore, in the case where the fixed unit 51 and the movable unit 55, etc., described above are provided for moving or rotating the DMD 551 in a plane including the X1X2 direction and the Y1Y2 direction, as the number of parts increases, further errors are likely to occur in the distance and the inclination.

Errors in the distance and the inclination cause a focal shift or distortion in the entire or part of the projection image. Furthermore, if the processing precision of the DMD reference surfaces 424a, 424b, and 424c and the holding member 555, etc., is further increased in an attempt to reduce errors in the distance and the inclination, the cost of parts will increase.

FIGS. 19A to 19E are diagrams illustrating the assembly adjustment of the optical engine according to the present embodiment.

FIG. 19A is a perspective view illustrating the overall configuration of the optical engine 15.

The optical engine 15 includes the illumination unit 40, the image display unit 50, and the projection optical unit 60. Similar to FIG. 18A, in FIG. 19A, the illumination unit 40 and the projection optical unit 60 are already assembled, and the state immediately before the image display unit 50 is assembled to the illumination unit 40, is illustrated.

The image display unit 50 is moved in the Z1 direction and assembled such that the DMD 551 of the image display unit 50 is disposed in the portion indicated by a solid line 411 of the illumination unit 40.

FIG. 19B is a diagram illustrating the enlarged part of the illumination unit 40 indicated by the solid line 411 in FIG. 19A.

As illustrated in FIG. 19B, in a casing 412 of the illumination unit 40, a rectangular opening 413 is formed at a position where the image generation surface of the DMD 551 is to be disposed when the image display unit 50 is assembled. Furthermore, in the casing 412, around the opening 413, unit reference surfaces 414a, 414b, 414c, and 414d, a unit main reference shaft 415, and a unit subordinate reference shaft 416 are formed.

The unit reference surfaces 414a, 414b, 414c, and 414d are reference surfaces with which a part of the surface of the top plate 511 of the image display unit 50 is brought into contact, when assembling the image display unit 50 to the illumination unit 40. By bringing the top plate 511 into contact with the unit reference surfaces, it is possible to set the distance between the illumination unit 40 and the image display unit 50 in the Z1Z2 direction, and to reduce the inclination of the illumination unit 40 and the image display unit 50.

By setting the unit reference surfaces 414a, 414b, 414c, and 414d as surfaces on four small circles, the area of the portion requiring processing precision is reduced. This reduces the processing cost as compared with the case where the entire surface of the casing 412 contacting the top plate 511 of the image display unit 50 is used as the reference surface. Note that the number of reference surfaces is not limited to four, and may be any number.

Furthermore, a female screw hole 414a1 is formed in the center portion of the unit reference surface 414a. Similarly, a female screw hole 414b1 is formed in the center portion of the unit reference surface 414b, a female screw hole 414c1 is formed in the center portion of the unit reference surface 414c, and a female screw hole 414d1 is formed in the center portion of the unit reference surface 414d.

The unit main reference shaft 415 and the unit subordinate reference shaft 416 are pin-shaped members to be fit into the reference holes provided in the top plate 511 of the image display unit 50, when the image display unit 50 is assembled to the illumination unit 40. By fitting the shafts in the holes, the positions of the illumination unit 40 and the image display unit 50 in the X1X2 direction and the Y1Y2 direction can be set. The unit main reference shaft 415 is the main reference shaft in setting the positions of the illumination unit 40 and the image display unit 50 in the X1X2 direction and the Y1Y2 direction.

FIG. 19C is a perspective view of the image display unit 50 illustrated in FIG. 19A as viewed in the Z2 direction. The image display unit 50 includes the DMD 551, the movable unit 55, and the fixed unit 51, etc. (see FIG. 6).

The movable unit 55 includes the movable plate 552, the coupling plate 553, and the heat sink 554, etc. The DMD 551 is fixed to one surface of the coupling plate 553, and the heat sink 554 is fixed to the other surface of the coupling plate 553. By being fixed to the movable plate 552, the coupling plate 553 can move with respect to the fixed unit 51 in accordance with the movement of the movable plate 552, together with the DMD 551 and the heat sink 554 (see FIG. 16).

The fixed unit 51 includes the top plate 511. Through the top plate 511, the image display unit 50 is assembled to the illumination unit 40.

In FIG. 19C, a unit main reference hole 5111 and a unit subordinate reference hole 5112 are formed around the DMD 551 in the top plate 511. As described above, the unit main reference shaft 415 is fit into the unit main reference hole 5111, and the unit subordinate reference shaft 416 is fit into the unit subordinate reference hole 5112.

FIG. 19D is a diagram illustrating the enlarged part of the device mounting screw indicated by a solid circle 503 in FIG. 19C. This part is a “screw part” for screwing and fixing the image display unit 50 to the illumination unit 40. The screw parts are provided at four positions in the plane including the X1X2 direction and the Y1Y2 direction. One of the four screw parts is enlarged in FIG. 19D.

As illustrated in FIG. 19D, at the screw part, a screw hole 5113a is formed in the top plate 511. When assembling the image display unit 50 to the illumination unit 40, a mounting screw 5114a is passed through the screw hole 5113a and is coupled with the female screw hole 414a1. Similarly, a mounting screw 5114b is passed through a screw hole 5113b and is coupled with the female screw hole 414b1. A mounting screw 5114c is passed through a screw hole 5113c and is coupled with the female screw hole 414c1. A mounting screw 5114d is passed through a screw hole 5113d and is coupled with the female screw hole 414d1. In this manner, the top plate 511 is screwed to the casing 412, and the image display unit 50 is fixed to the illumination unit 40.

Returning to FIG. 19A, the parts indicated by a broken-line circle 502 are spacers. When fixing the image display unit 50 to the illumination unit 40, a spacer is disposed between the image display unit 50 and the illumination unit 40, and is used for adjusting the distance between the image display unit 50 and the illumination unit 40.

FIG. 19E is a diagram illustrating the enlarged part of the broken-line circle 502 in FIG. 19A. As illustrated in FIG. 19E, in the present embodiment, three ring-shaped spacers 5523a, 5524a, and 5525a are used.

When fixing the image display unit 50 to the illumination unit 40, the spacers 5523a, 5524a, and 5525a are stacked in the Z1Z2 direction. Then, the mounting screw 5114a is passed through the center circular openings of the stacked spacers 5523a, 5524a, and 5525a. The mounting screw 5114a is coupled with the female screw hole 414a1 via the spacers 5523a, 5524a, and 5525a. Thereby, the image display unit 50 is fixed to the illumination unit 40.

The thicknesses of the spacers 5523a, 5524a, and 5525a are different from each other. For example, the thickness of the spacer 5523a is 250 μm, the thickness of the spacer 5524a is 200 μm, and the thickness of the spacer 5525a is 150 μm. In addition to these, a plurality of spacers having different thicknesses are prepared, and when fixing the image display unit 50 to the illumination unit 40, by selecting the thickness of the spacer to be disposed between the image display unit 50 and the illumination unit 40, it is possible to adjust the distance between the image display unit 50 and the illumination unit 40.

Furthermore, in the present embodiment, the diameters of spacers 5523a, 5524a, and 5525a are made different from each other in association with the thicknesses. For example, the spacer 5523a, the spacer 5524a, and the spacer 5525a are circular, the diameter of the spacer 5523a is 15 mm, the diameter of the spacer 5524a is 10 mm, and the diameter of the spacer 5525a is 5 mm.

It is difficult for an operator, who carries out the assembly adjustment, to visually distinguish the difference in thickness of 50 μm between the spacer 5523a and the spacer 5524a. However, if the difference in diameter between the spacer 5523a and the spacer 5524a is 5 mm, the difference can be recognized at a glance.

By previously defining the relationship between the thickness and the diameter of the spacer, the operator can recognize the thickness of the spacer by visually recognizing the diameter of the spacer. That is, the operator can visually recognize the thickness of the spacer. For example, as described above, the spacers 5523a, 5524a, and 5525a are configured such that the larger the area, or the larger the diameter, the greater the thickness. Specifically, if the diameter is larger by 5 mm, the thickness is greater by 50 μm. By knowing this relationship in advance, it is possible to easily visually recognize the difference in thickness and the thickness of the spacers 5523a, 5524a, and 5525a. In particular, in the case of the present embodiment, a proportional relationship is provided between the circular diameter of the spacer and the thickness, and, therefore, the difference in thickness between the spacers can be easily recognized. Furthermore, when the spacers 5523a, 5524a, and 5525a are configured to have a greater thickness as the area becomes smaller or the diameter becomes smaller as compared with each other, the same effect can be obtained as in the case of making the thickness greater as the area or the diameter becomes larger.

The spacer is disposed for each mounting screw at four positions where the mounting screws are provided. It is also possible to adjust the inclination of the image display unit 50 and the illumination unit 40 in the Z1Z2 direction by changing the thickness of the spacer for each mounting screw.

In this manner, by selecting and disposing a plurality of spacers having different thicknesses between the illumination unit 40 and the image display unit 50, the distance between the illumination unit 40 and the image display unit 50 can be adjusted. Even when there are manufacturing variations in the top plate 511 and the unit reference surfaces 414a, 414b, 414c, and 414d, etc., adjustments can be made such that the distance between the illumination unit 40 and the image display unit 50 in the Z1Z2 direction is set within a desired range and the inclination of the illumination unit 40 and the image display unit 50 is reduced to a desired range.

In the above description, the spacer through which the mounting screw can be passed is disposed for each mounting screw; however, it is not always necessary to be able to pass the screw through the spacer, and a spacer is not necessarily disposed for each mounting screw.

In the above description, three spacers having different thicknesses are stacked and disposed. However, the number of spacers to be stacked is not limited, and any number of spacers may be stacked and disposed.

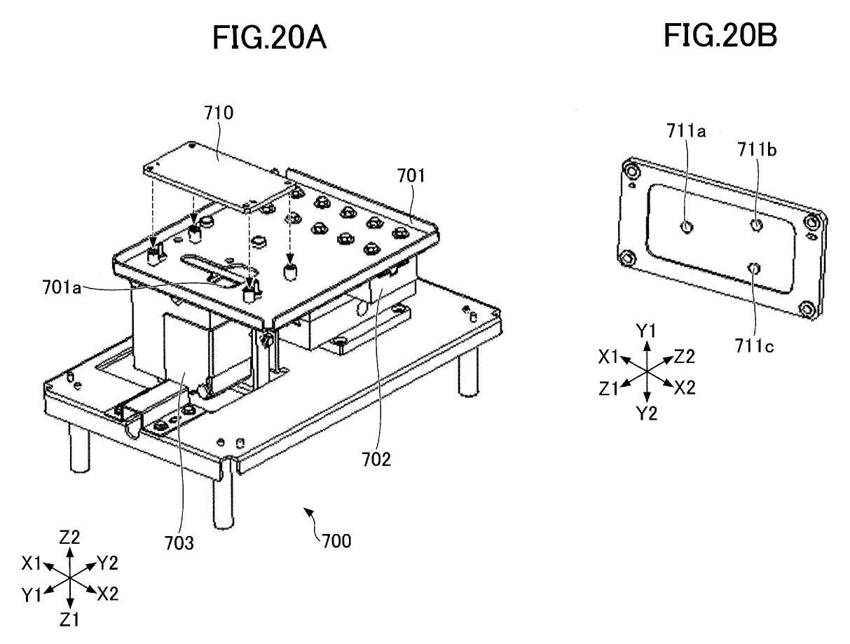

FIGS. 20A and 20B are diagrams illustrating an example of a configuration of an adjustment device for performing the assembly adjustment according to the present embodiment. FIG. 20A is a perspective view illustrating the overall configuration of the adjustment device. In FIG. 20A, an adjustment device 700 includes a base plate 701, a biaxial linear motion mechanism 702, and a displacement meter 703.

The base plate 701 is a plate member that holds an object to be adjusted. The base plate 701 is fixed to a table of the biaxial linear motion mechanism 702.

The biaxial linear motion mechanism 702 is a linear motion mechanism capable of advancing and returning in two axial directions of the X1X2 direction and the Y1Y2 direction. In the linear motion mechanism, for example, the rotational motion of a motor such as a stepping motor is converted into a linear motion by a ball screw, etc. The table connected to the ball screw via a nut can move linearly by the rotation of the motor. The biaxial linear motion mechanism 702 is formed by combining two linear motion mechanisms so as to be perpendicular to each other. The biaxial linear motion mechanism 702 causes the base plate 701 fixed to the table to advance and return in two axial directions of the X1X2 direction and the Y1Y2 direction.

The displacement meter 703 measures the position in the Z1Z2 direction and outputs the measurement result. Note that in the following description, the position in the Z1Z2 direction is referred to as the “height”. The displacement meter 703 is, for example, a laser displacement meter, and emits a laser beam toward a predetermined portion of the object to be adjusted. The displacement meter 703 measures the height of a predetermined portion of the object to be adjusted by receiving reflected light of the object to be adjusted.

The displacement meter 703 emits a laser beam toward a predetermined portion of the object to be adjusted that is fixed to the base plate 701, through a measurement opening portion 701a that is a rectangular hole provided in the base plate 701. In the measurement, the position of the base plate 701 in the X1X2 direction and the Y1Y2 direction is changed by the biaxial linear motion mechanism 702, and the portion of measuring the height of the object to be adjusted is changed.

In the assembly adjustment of the present embodiment, a master tool 710 is first set on the base plate 701 of the adjustment device 700. Here, the master tool 710 is a tool having a surface serving as a reference for the position in the Z1Z2 direction.

FIG. 20B is a perspective view when the master tool 710 illustrated in FIG. 20A is viewed in the Z2 direction. As illustrated in FIG. 20B, the master tool 710 includes master datum surface positions 711a, 711b, and 711c. The master datum surface positions 711a, 711b, and 711c are surfaces processed and adjusted to have equal heights, and are the surfaces serving as the reference of the height in the assembly adjustment according to the present embodiment.

The master tool 710 is fixed to the base plate 701 at four positions indicated by broken arrows in FIG. 20A. The heights of the master datum surface positions 711a, 711b, and 711c are measured by the displacement meter 703, and the respective measured values are recorded. Thereafter, the master tool 710 is detached from the base plate 701, and then the image display unit 50, which is the object to be adjusted, is set on the base plate 701.

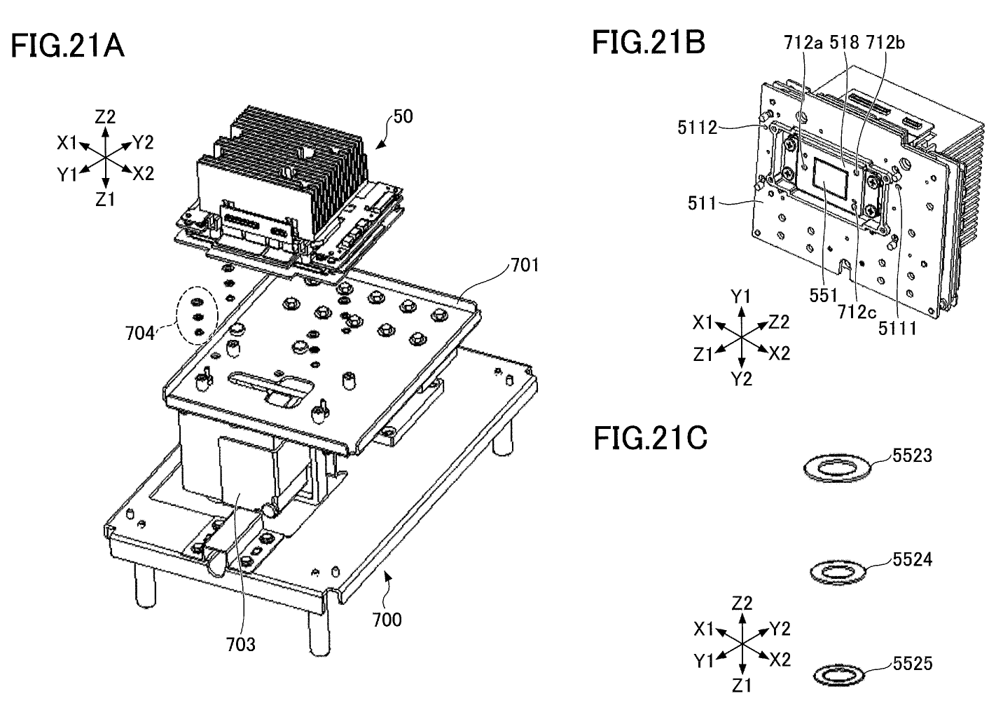

FIGS. 21A to 21C are diagrams for describing an example of how the adjustment device 700 assembles and adjusts the image display unit 50. FIG. 21A is a perspective view illustrating a state immediately before the image display unit 50 is set in the adjustment device 700. FIG. 21B is a perspective view of the image display unit 50 illustrated in FIG. 21A as viewed in the Z2 direction.

In FIG. 21B, DMD datum surface positions 712a, 712b, and 712c are formed on a substrate 518 to which the DMD 551 is fixed. As described above, the unit main reference hole 5111 and the unit subordinate reference hole 5112 are formed in the top plate 511.

The unit main reference hole 5111 and the unit subordinate reference hole 5112 are aligned in the X1X2 direction and the Y1Y2 direction, and the image display unit 50 is fixed to the base plate 701. FIG. 21C is a diagram in which the portion of a broken-line circle 704 in FIG. 21A is enlarged. In FIG. 21C, three ring-shaped spacers 5523, 5524, and 5525 are illustrated. The spacers 5523, 5524, and 5525 are stacked in the Z1Z2 direction and are disposed between the image display unit 50 and the base plate 701 at each of the positions of four mounting screws in the image display unit 50.

In the assembly adjustment, when setting the image display unit 50 on the base plate 701, first, a combination of spacers having a standard thickness is used. The image display unit 50 is fixed to the base plate 701 in a state where the standard spacers are disposed in combination. The displacement meter 703 measures the heights of the DMD datum surface positions 712a, 712b, and 712c.

Next, the measurement values of the heights are compared, between the DMD datum surface position 712a and the master datum surface position 711a. When there is a deviation between these two positions, the combination of the spacer thicknesses is selected so as to correct this deviation. Similarly, the measurement values of the heights are compared, between the DMD datum surface position 712b and the master datum surface position 711b. When there is a deviation between these two positions, the combination of the spacer thicknesses is selected so as to correct this deviation. Furthermore, the measurement values of the heights are compared, between the DMD datum surface position 712c and the master datum surface position 711c. When there is a deviation between these two positions, the combination of the spacer thicknesses is selected so as to correct this deviation.

At this time, as described above, the operator can select the combination of the thicknesses of the spacers, while viewing the difference in the thicknesses of the spacers, by visually recognizing the difference in size such as the diameters of the spacers.

The spacers with the corrected thickness are disposed for each mounting screw, and the image display unit 50 is assembled to the illumination unit 40. Accordingly, the distance between the image display unit 50 and the illumination unit 40 is adjusted, and the optical engine 15 is assembled.

Note that in the above description, each of the number of master datum surface positions and the number of DMD datum surface positions is three; however, the present invention is not limited thereto, and any number of positions may be used.

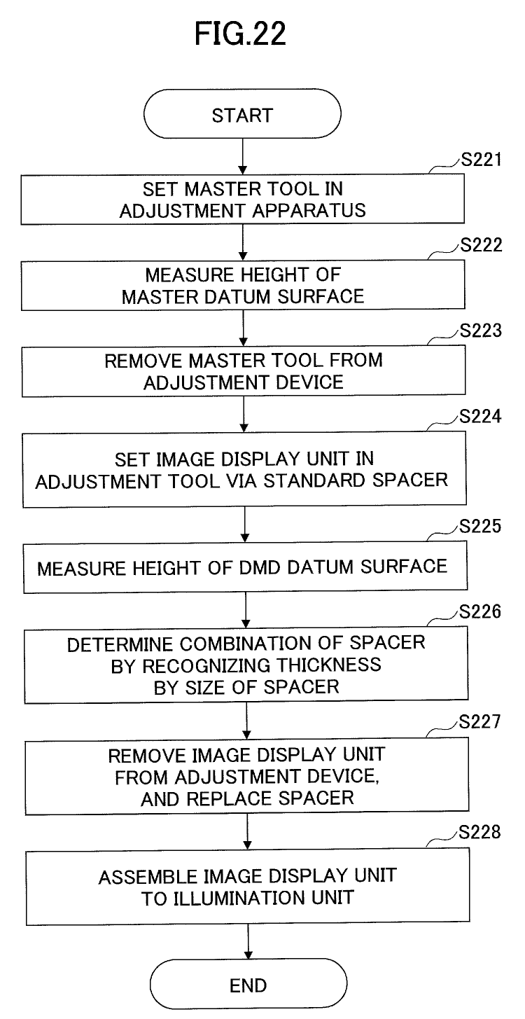

FIG. 22 is a flowchart illustrating an example of the adjustment method of the present embodiment.

First, the operator sets the master tool 710 on the base plate 701 of the adjustment device 700 (step S221).

Next, the operator measures the respective heights of the master datum surface positions 711a, 711b, and 711c with the displacement meter 703, and records the measured values (step S222).

Next, the operator removes the master tool 710 from the adjustment device 700 (step S223).

Next, the operator places a standard spacer for each position of the mounting screw of the image display unit 50, and sets the image display unit 50 on the base plate 701 of the adjustment device 700 (step S224).

Next, the operator measures the height of each of the DMD datum surface positions 712a, 712b, and 712c with the displacement meter 703, and records the measured values (step S225).

Next, the operator compares the master datum surface position 711a with the DMD datum surface position 712a, compares the master datum surface position 711b with the DMD datum surface position 712b, and compares the master datum surface position 711c with the DMD datum surface position 712c, respectively. If there is a difference between the compared positions, the combination of spacers is selected so as to correct the difference. The operator visually recognizes the difference in the size of the spacers, and selects and determines the combination of the spacers while visually recognizing the difference in the thickness of the spacers (step S226).

Next, the operator removes the image display unit 50 from the adjustment device 700 and replaces the spacers with the determined combination of spacers (step S227).

Next, the operator places the determined combination of spacers for each mounting screw, and assembles the image display unit 50 to the illumination unit 40 (step S228).

In this way, the operator can adjust the distance between the image display unit 50 and the illumination unit 40 and assemble the optical engine 15.

Note that step S227 and beyond may be appropriately changed. For example, after replacing the spacers, the image display unit 50 may be set again on the base plate 701 of the adjustment device 700. Then, the height of each of the DMD datum surface positions 712a, 712b, and 712c may be measured with the displacement meter 703 to reconfirm whether the height is the desired height.

As described above, according to the present embodiment, a plurality of spacers having different thicknesses to be disposed between the illumination unit and the image display unit, are formed such that the spacers are different in terms of the size of the surface perpendicular to the thickness direction. Accordingly, the difference in the thickness between the spacers can be visually recognized. Thus, it is possible to efficiently adjust the distance between the illumination unit and the image display unit by visual recognition. Furthermore, the manufacturing efficiency of the optical engine and the image projection apparatus can be improved.

In the present embodiment, an example in which spacers are disposed between the illumination unit 40 and the image display unit 50 is indicated; however, the present invention is not limited as such. For example, spacers may be disposed between the illumination unit 40 and the projection optical unit 60, and the distance between the illumination unit 40 and the projection optical unit 60 may be similarly adjusted.

Furthermore, by photographing the spacers with a camera, etc., it will be easy to automatically recognize the difference in the thicknesses of the spacers. Therefore, it is also possible to automatically recognize the difference in the thickness of the spacers without using an expensive measuring device, and to automate the adjustment of the distance between the illumination unit and the projection optical unit, etc.

### Second Embodiment

In the first embodiment, an example in which the difference in the thickness between the spacers can be visually recognized by changing the sizes of the diameters, etc., of the spacers, has been described; however, the present invention is not limited as such. For example, the shape of the spacer on the surface perpendicular to the thickness direction may be changed so that the difference in the thickness between the spacers can be visually recognized. Specifically, the shape of a spacer having a thickness of 250 μm is a pentagon, the shape of a spacer having a thickness of 200 μm is a rectangle, and the shape of a spacer having a thickness of 150 μm is a triangle. By viewing the shape of the spacer, it is possible to recognize the difference in the thickness between the spacers.

When the sizes of the spacers are made different as in the first embodiment, it is sometimes difficult to recognize the difference at a glance if the difference in size is small. For example, it may be difficult to recognize at a glance the difference between a spacer with a diameter of 9 mm and a spacer with a diameter of 10 mm.

According to the present embodiment, the shape of the spacer, on the surface perpendicular to the thickness direction, is different for each thickness of the spacer, and, therefore, the difference between the spacers can be made easier to recognize. That is, it is possible to visually recognize the difference in the thickness between the spacers more easily. For example, as described above, a plurality of spacers are configured such that as the number of corners of the shape becomes larger, the thickness becomes greater, as compared with each other. Specifically, it is assumed that for every one more corner, the thickness increases by 50 μm. By knowing this relationship in advance, it is possible to easily visually recognize the difference in the thickness between the spacers, and to visually recognize the thickness of each spacer. In particular, in the present embodiment, there is a proportional relationship between the number of corners of the shape of the spacer and the thickness of the spacer, and, therefore, the difference in the thickness between the spacers can be easily recognized. Furthermore, in a case where the smaller the number of corners, the greater the thickness as compared with each other, the same effects can be obtained as in the case where the larger the number of corners, the greater the thickness.

The other effects are similar to those described in the first embodiment.

According to one embodiment of the present invention, it is possible to visually recognize the difference in thickness between spacers such as plate members to be disposed between an illumination unit and an image display unit or between an illumination unit and a projection optical unit.

The image projection apparatus is not limited to the specific embodiments described in the detailed description, and variations and modifications may be made without departing from the spirit and scope of the present invention.

What is claimed is:

1. An image projection apparatus comprising:
an image displayer on which an image is formed;
an illuminator configured to illuminate the image displayer; and
an optical projector configured to project the image formed on the image displayer, wherein
a plurality of spacers having different thicknesses from each other is disposed between the illuminator and the image displayer or between the illuminator and the optical projector, and
each of the plurality of spacers having a different thickness is configured to have a greater thickness as a size is larger, or to have a greater thickness as the size is smaller, the size being a size of a surface perpendicular to a thickness direction of each of the plurality of spacers.

2. An image projection apparatus comprising:
an image displayer on which an image is formed;
an illuminator configured to illuminate the image displayer; and
an optical projector configured to project the image formed on the image displayer, wherein
a plurality of spacers having different thicknesses from each other is disposed between the illuminator and the image displayer or between the illuminator and the optical projector, and
each of the plurality of spacers having a different thickness has a surface perpendicular to a thickness direction shaped as a polygon, and each of the plurality of spacers is configured to have a greater thickness as a number of corners of the polygon is larger, or to have a greater thickness as the number of corners is smaller.

3. The image projection apparatus according to claim 1, wherein
each of the plurality of spacers is circular, and
a diameter and the thickness of each of the plurality of spacers have a proportional relationship or an inverse proportional relationship.

4. The image projection apparatus according to claim 2, wherein the number of corners and the thickness of each of the plurality of spacers have a positive proportional relationship or a negative proportional relationship.

5. The image projection apparatus according to claim 1, wherein
the image displayer includes:
a first fixed plate that is fixedly supported;
a second fixed plate that is fixedly supported by the first fixed plate;
a first movable plate that is movable in a predetermined direction, the first movable plate being provided between the first fixed plate and the second fixed plate;
a second movable plate that is fixed to the first movable plate, with the second fixed plate interposed between the second movable plate and the first movable plate; and
an image generator configured to generate the image by using light emitted from a light source, the image generator being provided on the second movable plate.

6. The image projection apparatus according to claim 2, wherein
the image displayer includes:
a first fixed plate that is fixedly supported;
a second fixed plate that is fixedly supported by the first fixed plate;
a first movable plate that is movable in a predetermined direction, the first movable plate being provided between the first fixed plate and the second fixed plate;
a second movable plate that is fixed to the first movable plate, with the second fixed plate interposed between the second movable plate and the first movable plate; and
an image generator configured to generate the image by using light emitted from a light source, the image generator being provided on the second movable plate.
